(19) United States
(12) Patent Application Publication
(10) Pub. No.: US 2019/0059333 A1
(43) Pub. Date: Feb. 28, 2019

(54) Quick Release Shear Resistant Magnetic Collar and Combination Choke Leash Apparatus

(71) Applicant: Colin J. Lagarde, New Orleans, LA (US)

(72) Inventor: Colin J. Lagarde, New Orleans, LA (US)

(21) Appl. No.: 16/113,769

(22) Filed: Aug. 27, 2018

Related U.S. Application Data
(60) Provisional application No. 62/552,127, filed on Aug. 30, 2017.

(51) Int. Cl. A01K 27/00

(52) U.S. Cl. CPC A01K 27/005; A01K 27/003; A01K 27/001

(57) ABSTRACT

A quick release shear resistant magnetic collar and combination leash apparatus is provided to enable rapid deployment of a leash portion and maintain control of an animal. A fastener member is disposed at a first end of a belt member and the leash portion is disposed at a second end of the belt member. The second end is threaded through the fastener member so that the leash portion is double-backed to overlie the belt member. The leash portion is coupled to the belt member proximal the first end by action of each of a first and second magnet. Force applied to the belt member is borne predominantly by the ring member until the leash portion is grasped manually and pulled orthogonally away from the belt member, whereby the leash portion is deployed. In at least one embodiment, the collar thence operates as a choke collar.

### BACKGROUND OF THE INVENTION

Various types of leashes and collars are known in the prior art. Many include retractable and deployable components devised to enable ranging of a tethered animal while controlled in the hands of a user. Such embodiments contemplated in the prior art include spring-loaded elements required to rewind a leash portion back into some housing to maintain a tidy and stowed configuration of the leash when not in use. Various types of collars incorporating means to house retractable leashes therein are known in the art. Some rely on quick release fasteners and configurations of hook and loop connections. However, what is needed is a quick release shear resistant magnetic collar and combination leash apparatus that enables deployment of a leash without any such housing required wherein a user may exigently grasp a handle portion of a belt member, disposed encircling an animal's neck, and break each of a first and second magnet from engagement together, whereby a leash portion is rapidly separable from overlying the belt member and the belt member is suddenly operable as a collar when the leash portion is tensioned in the hands of a user.

### FIELD OF THE INVENTION

The present invention is devised for manually tethering pets and animals, such as dogs, for example. The present invention relates to collars and leashes in general, and, more particularly, to a quick release shear resistant magnetic collar and combination leash apparatus that includes a belt member having a first end and a second end disposed for collaring an animal for expedient deployment between an encircled configuration and a leash configuration.

A fastener member, disposed at the first end, is devised for threadable engagement of the second end therethrough, whereby a leash portion of the belt member is foldable double-backed overlying the belt member and thereby securable in the encircled configuration by action of each of a first magnet and a second magnet disposed for magnetic engagement together upon the belt member. The first magnet is disposed in a first magnet seat disposed proximal the second end of the belt member. The second magnet is disposed in a second magnet seat disposed spaced apart from the first magnet seat along the length of the belt member. The diameter of the belt member when disposed around an animal's neck and the length of the leash portion disposed threaded through the fastener member and disposed to overlie the belt member when in the encircled configuration both depend on the relative position of each of said first and second magnet seats.

The present quick release shear resistant magnetic collar and combination leash apparatus is thence maintainable about the neck of an animal while in the encircled configuration until the leash portion is deployed by manual action disposed to effect separation of each of said first and second magnets by forcing along an orthogonal plane relative said first and second magnets, whereby the quick release shear resistant magnetic collar and combination leash apparatus is expediently deployable into a leash configuration for control of an animal wieldable thereby.

### SUMMARY OF THE INVENTION

Many people enjoy walking their pets and allowing them greater latitude and free reign during exercise. However, many locations require controlling pets and animals when operating in particular communities and within communal or public spaces whereat leash laws are strictly enforced. In some instances, it is desirable to allow a pet free reign while advantaging a tether deployable in exigent or expedient circumstances, whereby control over an animal may be quickly enforced.

The present quick release shear resistant magnetic collar and combination leash apparatus has been devised to enable rapid deployment of a leash portion of said collar from a stowed, encircled configuration maintained about the neck of the animal, to enable expedient tethering and control of an animal subsequent allowing the animal free reign. The leash portion is likewise rapidly returnable to the encircled position by action of magnetic force whereby a user may return the leash portion to the encircled configuration without necessarily stooping to do so. While the present invention is particularly adapted for use with domestic dogs it should be evident to anyone of ordinary skill in the pertinent art that the present device may be usable with any animal for which such quick release shear resistant magnetic collar and combination leash apparatus is desirable.

The present quick release shear resistant magnetic collar and combination leash apparatus, therefore, includes a belt member devised to collar around the neck of an animal. The belt member includes a first end and a second end. A fastener member is disposed at the first end for threadable engagement of the second end therethrough, whereby a leash portion of the belt member is foldable overlying the belt member into an encircled configuration thereupon.

The leash portion is maintained in contact overlying the belt member by action of a first magnet, disposed in a first magnet seat housed in the belt portion, engaging against a second magnet, disposed in a second magnet seat housed along the length of the belt member and spaced apart from the first magnet seat thereupon. Attraction of the magnetic force between said first and second magnets maintains the belt member disposed in contact with the leash portion whereby the leash portion is maintainable stowed overlying the belt member. When the second end is stowed to the belt member, the quick release shear resistant magnetic collar and combination choke leash apparatus is disposed in an encircled configuration.

When deployment of the leash portion is thence desirable, a user merely grabs the second end and pulls orthogonally to effect forced separation of the first and second magnets. The leash portion is thereby forcible away from contact at the second magnet seat and is thence usable as a tether in the hand of a user. In a first embodiment, the belt member is enabled unimpeded slippage through the fastener member whereby the belt member serves as a choke collar—that is, a collar able to tighten when the leash portion is tensioned. Thus the animal tethered to the user's hand is controllable and pulling and tensioning by the animal against the leash portion is preventable by action of the belt member tightening around the animal's neck.

In a second embodiment the belt member is fastened together at a fastened point proximal a mid-portion of the belt member, to prevent unimpeded slippage through the fastener member whereby the belt member serves as a collar that does not tighten around the animal's neck when pulled. In a third embodiment the fastener is affixed between the belt member and the leash portion and thereat securable into a quick release seat disposed at the first end.

In some embodiments contemplated herein, a handle member may be disposed at the second end to assist in visually and tactilely locating the second end for manually effected separation of the first and second magnets and thereby facilitate rapid deployment of the leash portion to tether and control the animal thereby. Separation of the first and second magnets is expediently effected when said magnets are separated along an orthogonal plane relative one another—that is, when the first and second magnets are pulled diametrically apart as opposed to laterally disjoining them along opposing but parallel planes. When the quick release shear resistant magnetic collar and combination leash apparatus is disposed in the encircled configuration, force applied against the collar is applied predominantly at the ring member whereat the leash portion is folded, doubled-back, and overlain the belt member. Such force is distributed along the length of the belt member and applied longitudinally therethrough whereby the first and second magnets are pulled in lateral, parallel planes wherein the magnetic force remains yet powerful. Such forcing of the collar as may be effected by any action ordinarily undertook by the animal wearing the collar is therefore unlikely to effect separation of the first and second magnets whereby the belt member is maintained in the encircled configuration around the animal's neck. Further, should a user wish to grab the collar, such tension is likewise applied along the length of the belt member and distributed predominantly at the fold of the leash portion of the belt member disposed at the ring member. This makes separation of the first and second magnets less likely due to forcing separation along a relative shear angle (as discussed above). Further, because the leash portion is disposed immediately overlying the belt member, a user determining to grab the collar will most frequently grab the belt member and the leash portion overlying thereatop, whereby grasping the animal by the collar will further act to maintain position of the quick release shear resistant magnetic collar and combination leash apparatus in the encircled position and thus prevent the animal's escape.

Returning the leash portion to the encircled configuration may likewise be expedited by the magnetic force whereby a user may restore the leash portion to the encircled configuration by tossing the leash portion into the encircled configuration whereby the first and second magnets snap together. Restoration of the leash portion to the encircled configuration may therefore be expediently performed without the user necessarily having to stoop into proximity of the animal's neck.

Attachment of a separate leash (not shown) to the fastener member also enables use of the present quick release shear resistant magnetic collar and combination leash apparatus as a typical collar in the traditional way; that is, attachment to a separate and distinct leash that is attachable at the fastener member in like manner as presently seen in the art. In such usages, the first and second magnets are positioned to enable connection where the length of the leash portion is disposed overlying the belt member to prevent ready separation of said first and second magnets from force applied at the fastener member. Thus use with additional, extant leashes (not shown) is enabled without the collar undoing from force applied at the ring member.

Deployment of the leash portion when desired is expediently performed by a user grabbing the second end of the belt member. Force thence exerted orthogonally relative the belt member will effect separation of the first and second magnets and deploy the quick release shear resistant magnetic collar and combination leash apparatus in the leash configuration.

The configuration of the first and second magnets enables reversible wear of the present quick release shear resistant magnetic collar and combination leash apparatus whereby each of a contrary and visually distinct collar may be worn out-facing by the animal to which the collar is applied. Thus, in some circumstances when a visually distinct color is desirably worn upon the animal (such as bright orange, for example, when hunting), the collar may be reversibly worn to present the distinct color exteriorly situated and visually signal the presence of the animal. The quick release shear resistant magnetic collar and combination choke leash is therefore readily and expediently reversible when desired.

Thus has been broadly outlined the more important features of the present quick release shear resistant magnetic collar and combination leash apparatus so that the detailed description thereof that follows may be better understood and in order that the present contribution to the art may be better appreciated.

For better understanding of the quick release shear resistant magnetic collar and combination leash apparatus, its operating advantages and specific objects attained by its uses, refer to the accompanying drawings and description.

### BRIEF DESCRIPTION OF THE DRAWINGS

### Figures

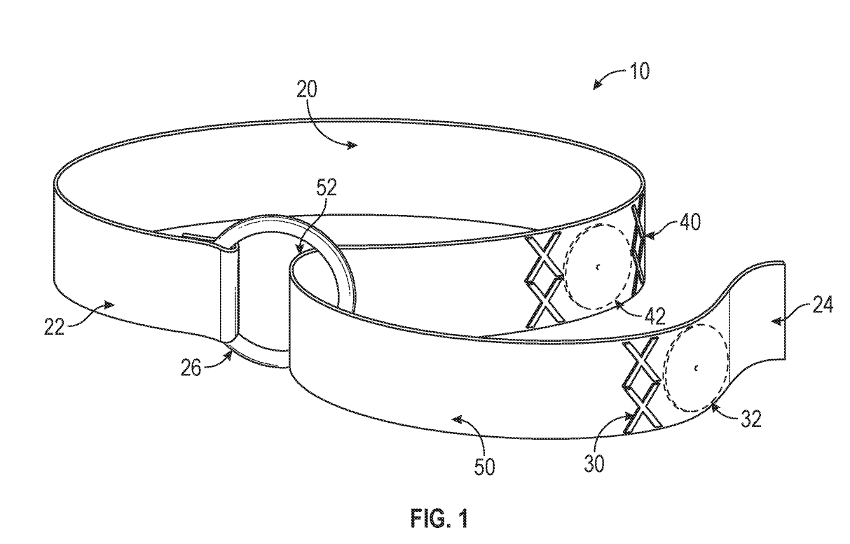

FIG. 1 is an elevation view of an example embodiment disposed in an encircled configuration with each of a first and second magnet not yet joined.

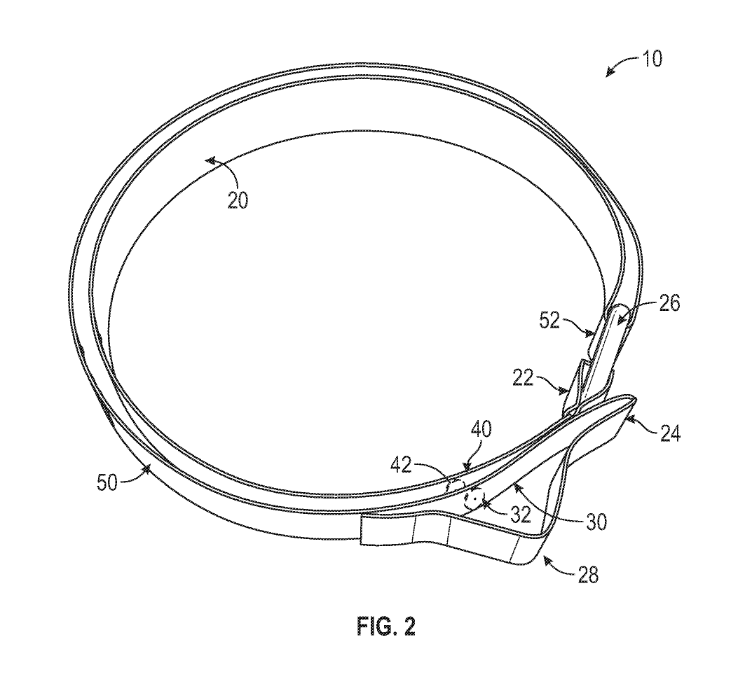

FIG. 2 is a front elevation view of an example embodiment in an encircled configuration.

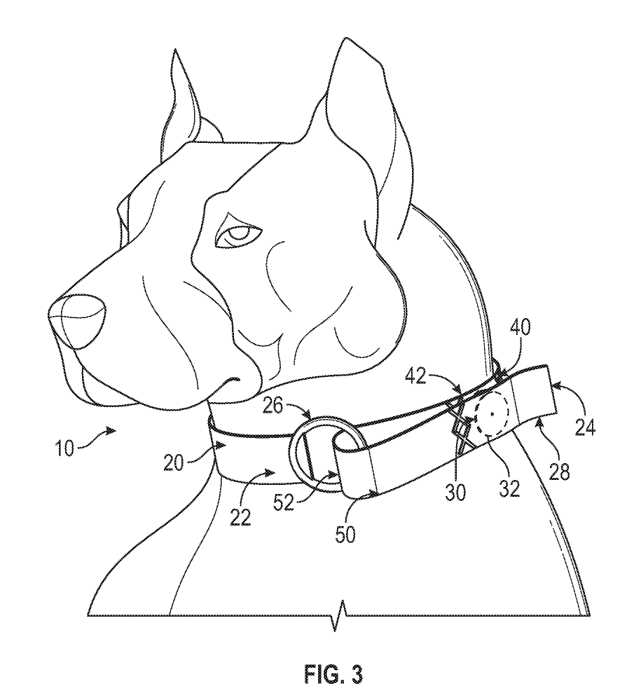

FIG. 3 is an in-use view of an example embodiment disposed in the encircled configuration around the neck of an animal.

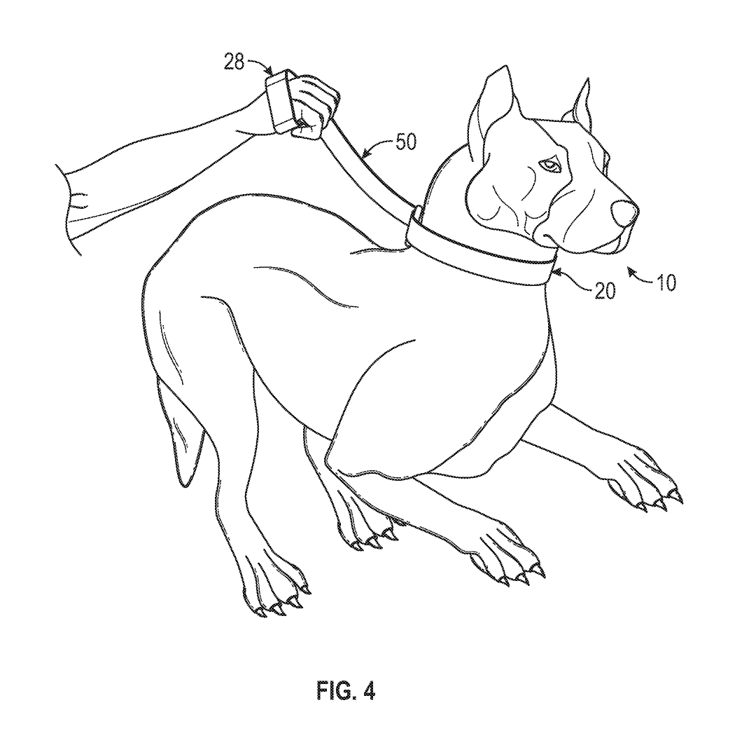

FIG. 4 is an in-use view of an example embodiment deployed in a choke leash configuration.

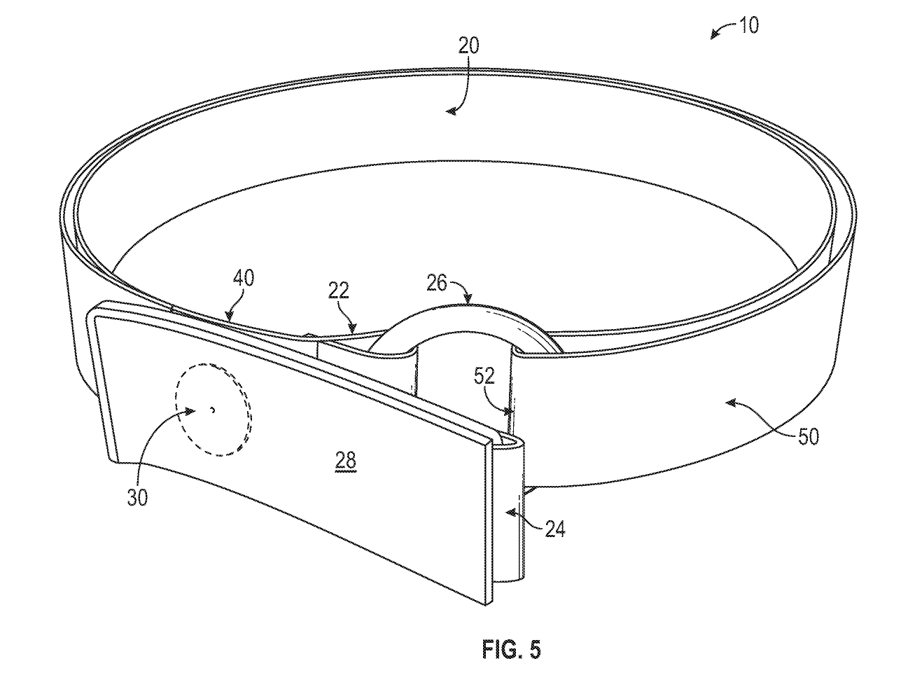

FIG. 5 is an elevation view of an example embodiment having a handle member disposed at a second end.

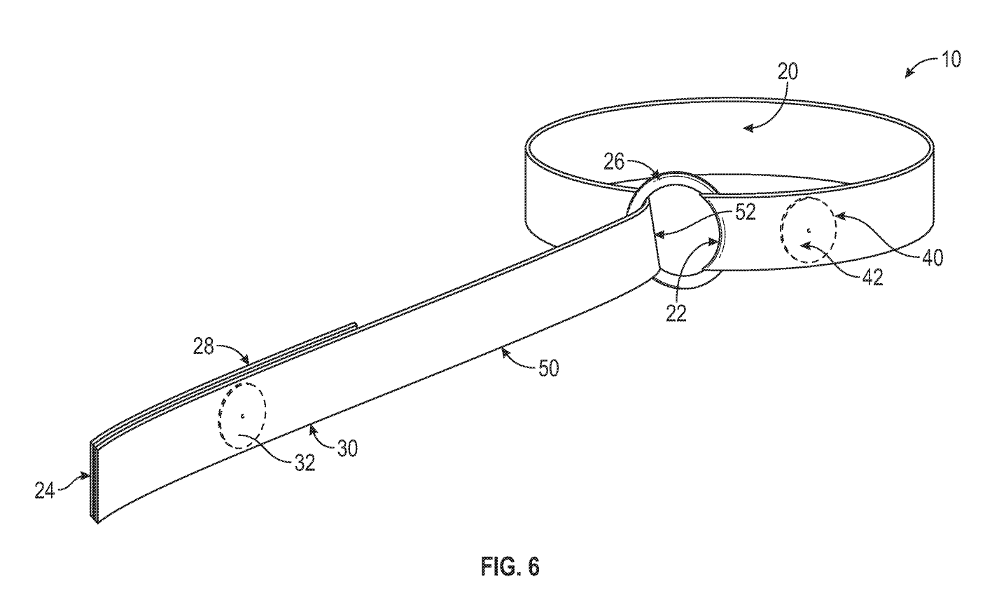

FIG. 6 is an elevation view of an example embodiment disposed in the choke leash configuration.

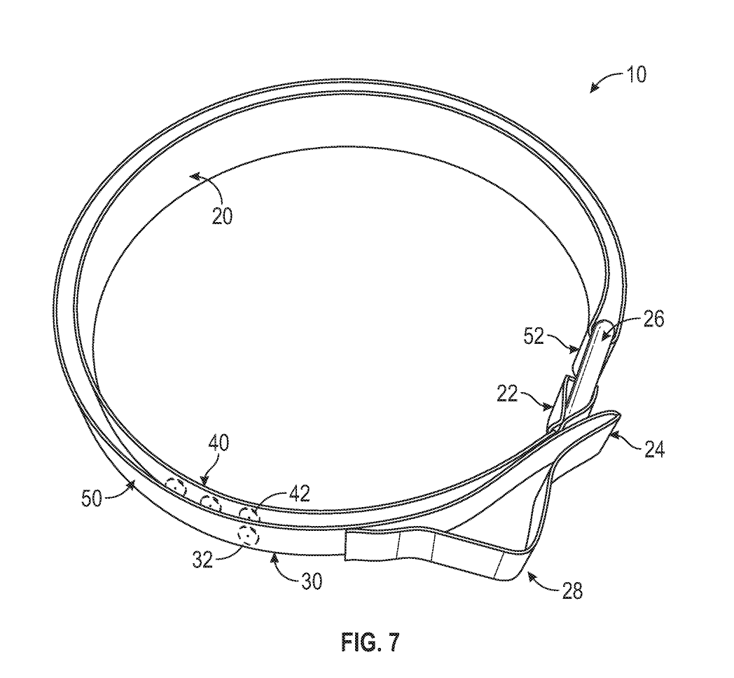

FIG. 7 is an elevation view of an example embodiment disposed in the encircled configuration and having a plurality of second magnets disposed along the second magnet seat proximal the first end of the belt member.

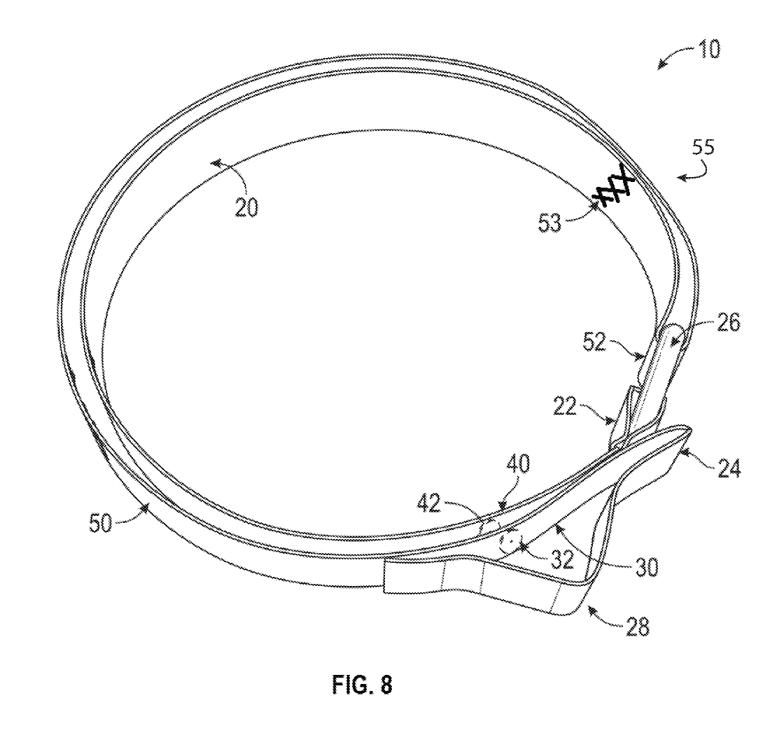

FIG. 8 is an elevation view of an example embodiment disposed in the encircled configuration and having a fastened point proximal a mid-portion of the belt member to prevent unimpeded slippage of the belt member through the ring member when the belt member is deployed into the leash configuration.

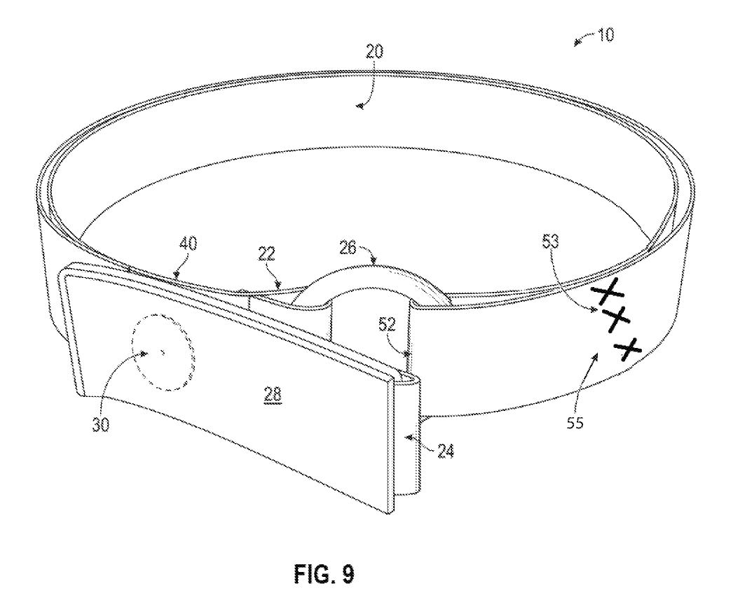

FIG. 9 is a front elevation view of an example embodiment disposed in the encircled configuration and having the fastened point proximal a mid-portion of the belt member to prevent unimpeded slippage of the belt member through the ring member when the belt portion is deployed into the leash configuration.

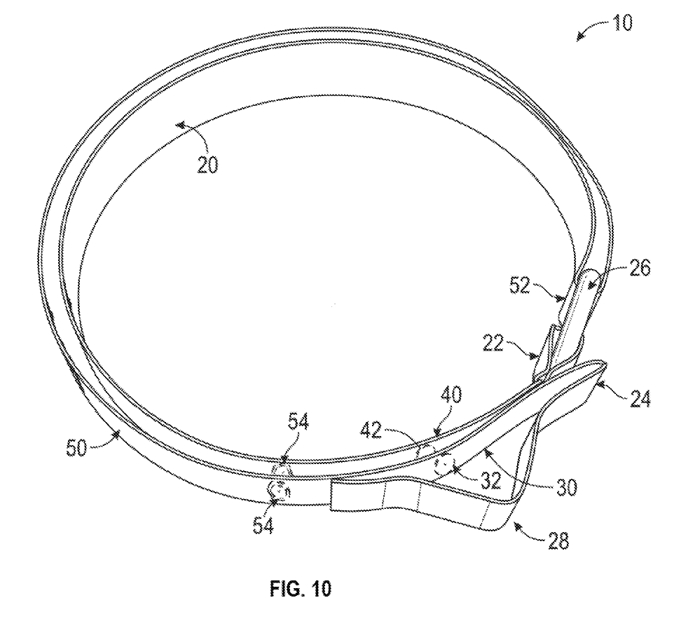

FIG. 10 is a front elevation view of an example embodiment disposed in the encircled configuration and having an additional securement member disposed proximal the second end of the belt member to maintain position of the belt member encircled and connection of each of the first and second magnets.

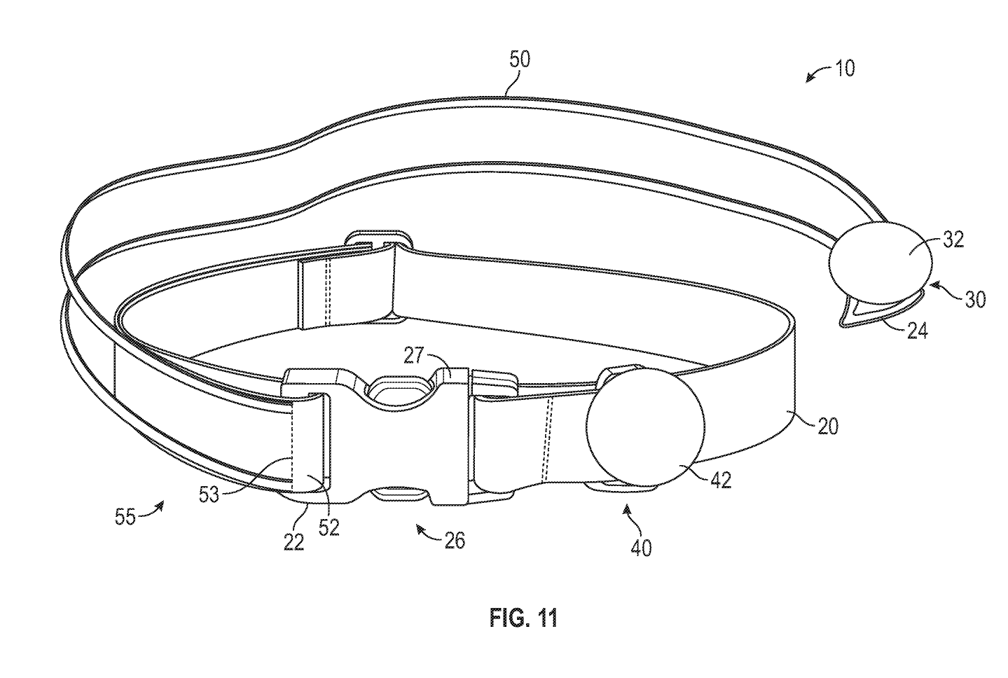

FIG. 11 is an elevation view of an example embodiment having a fastener disposed between the leash portion and the belt member, said fastener connectable into a quick release seat disposed at the first end.

### DETAILED DESCRIPTION OF THE DRAWINGS

With reference now to the drawings, and in particular FIGS. 1 through 11 thereof, example of the instant quick release shear resistant magnetic collar and combination leash apparatus employing the principles and concepts of the present quick release shear resistant magnetic collar and combination leash apparatus and generally designated by the reference number 10 will be described.

Referring to FIGS. 1 through 11 preferred embodiments of the quick release shear resistant magnetic collar and combination leash apparatus 10 are illustrated.

The present quick release shear resistant magnetic collar and combination leash apparatus 10 is contemplated for wear by an animal with a second end 24 of a leash stowed in contact overlying a belt member 20 wherein efficient and rapid tethering of an animal to its owner is enabled when the second end 24 is grasped and deployed as a leash whereby free reign of the animal is enabled until tethering is desirable or required.

The present quick release shear resistant magnetic collar and combination leash apparatus 10, therefore, is deployable from an encircled configuration disposed around the neck of an animal into a leash configuration, whereby a second end 24 is deployed as a leash. Manual action effected to grab a handle portion 28, disposed at the second end 24 of a belt member 20, is effective to break apart each of a first magnet 32 and a second magnet 42, to deploy the second end 24 from contact maintained overlying the belt portion 20 for use as a leash.

Each of the first and second magnets 32, 42 secure the second end 24 overlying the belt member 20 when the second end 24 is not deployed as a leash, to stow the second end 24 to the belt member 20 and maintain the belt member 20 in the encircled configuration around the neck of an animal (see for example FIGS. 2, 3, and 7). The handle portion 28 is thus stowed flush to the belt member 20 in a position appropriate for expedient manual grasping and is there maintained when the second end 24 is stowed in the encircled configuration. The handle member 28 is thus conveniently locatable whenever a user desires to break the first and second magnets 32, 42 apart and deploy a leash portion 50 as a leash to tether the animal appropriately (as shown in FIGS. 4 and 6 for example).

As shown in FIG. 1, the present quick release shear resistant magnetic collar and combination leash apparatus 10, therefore, includes a belt member 20 having a first end 22 and a second end 24. A fastener member 26 is disposed at the first end 22. In the example embodiment shown in FIG>1, for example, the fastener member 26 is sized appropriate to accommodate the second end 24 of the belt member 20 therethrough. A leash portion 50 of the belt member 20 is disposed at the second end 24, said leash portion 50 devised for threadable engagement through the fastener member 26 in some embodiments, whereby the leash portion 50 may be doubled-back through the ring member 26 to overlie the remaining portion of the belt member 20.

The leash portion 50 may be a portion of the belt member 20 suited for engagement in an encircled configuration and thereby sized to fit a particular animal (see below). The leash portion 50 may include reinforced portions or be indistinguishable from the belt member 20 proper. The leash portion 50 is at least a portion of the belt member 20 maintained doubled-back overlying the belt member 20 when the present quick release shear resistant magnetic collar and combination leash apparatus 10 is stowed in the encircled configuration (see for example FIGS. 1 and 2).

As shown in FIG. 2, the belt member 20 may, therefore, be encircled around the neck of an animal whereby the second end 24, threaded through the ring member 26, secures the belt member 20 in an encircled configuration about the neck of the animal and the leash portion 50 is maintainable to tether the animal in the hand. Any force against the belt member 20 is distributed predominantly to the fastener member 26 where the belt member 20 is doubled-back. The distribution of force to a fold 52 of the belt member 20 at the fastener member 26 assists in maintaining the belt member 20 in the encircled configuration, as will be explained subsequently.

A first magnet seat 30 is disposed proximal the second end 24 of the belt member 20, said first magnet seat 30 disposed to securably house a first magnet 32 therein. A second magnet seat 40 is disposed upon the belt member 20 spaced apart from the first magnet seat 30 along the length of the belt member 20. A second magnet 42 is disposed within the second magnet seat 40 and there devised to engage with the first magnet 32 when the second end 24 of the belt member 20 is positioned proximal thereto, whereby the leash portion 50 of the belt member 20 may be overlain upon the belt member 20 and secured thereat by action of the first and second magnets 32, 42 together.

The first magnet seat 30 is disposed at, or proximal, the second end 24 of the belt member 20. The second magnet seat 40 is disposed spaced apart from the first magnet seat 30 some distance along the length of the belt member 20. The position of the second magnet seat 40 located along the belt member 20 determines a specific diameter of the belt member 20 when said belt member 20 is disposed in the encircled configuration. The proximity of the second magnet seat 40 relative the first end 22 of the belt member 20, for example, thus effects the overall diameter of the belt member 20 when secured in the encircled configuration and, secondly, the length of the leash portion 50 of the belt member 20 which is deployable as a leash when desired. The shortest diameter, and the longest leash portion 50 deployable as a leash, is effected by maximizing the distance between the first and second magnet seats 30, 40 along the length of the belt member 20; that is, where the first magnet seat 30 is disposed at the second end 24 and the second magnet seat 40 is disposed at the first end 22 of the belt member 20 (see FIGS. 2 and 5, for example). A variety of sized collars is thus entertained and contemplated herein with mind to the example embodiments illustrated, whereby use of the present invention 10 is adaptable for different sized animals and different breeds of dogs, for example.

It is further contemplated that the second magnet seat 40 may have a longitudinal dimension, or circumferential length along the belt member 20, whereby a plurality of second magnets, for example, or other magnetic members, may be disposed therein enabling coupling of the first magnet 32 to the second magnet seat 40 along some longitudinal length thereof (see FIG. 7, for example). Thus an embodiment of the present invention 10 capable of securing across a variety of sizes in the encircled configuration is contemplated herein for use between several different sized animals, as case may be.

It is important to note that a shear angle effected between the first and second magnets 32, 42 assists to maintain the second end 24 of the belt member 20 threaded through the ring member 26 disposed at the first end 22 and doubled-back overlying the belt member 20. The belt member 20, when stowed in the encircled configuration about the neck of an animal, places a tension force predominantly against the fastener member 26 at the resulting fold 52 formed in the belt member 20. The attraction of the first and second magnets 32, 42 thus maintains the second end 22 in contact with the belt member 20 whereby less force is exerted against each of the first and second magnets 32, 42 than at the fold 52 maintained at the fastener member 26, when the belt member 20 is disposed in the encircled configuration around the neck of an animal, and where said animal is able to exert any force against the belt member 20. Further, any such force as may be effected between the first and second magnets 32, 42 by action of the animal wearing the belt member 20 in the encircled configuration is most apt to pull the first and second magnets 32, 42 along a relative shear angle, to effectively slide laterally over each other and attempt forced separation along parallel planes, whereby the magnetic force remains yet powerful. To pull each of the first and second magnets 32, 42 apart by forcing along parallel planes, but in contrary directions, is more difficult that separating said magnets 32, 42 by diametrically forcing them apart along an orthogonal plane. In an example embodiment disclosed herein, each of the first and second magnets 32, 42 is a powerful magnet, such as a super neodymium magnet. Additional magnets and magnetic materials are contemplated herein. (For example, a single magnet may be contemplated in one magnet seat devised to attach to a magnetic receptacle housed at a corresponding magnetic seat wherein sizability of the quick release shear resistant magnetic collar and combination leash apparatus is enabled.)

Deployment of the second end 24 from the encircled configuration, therefore, is best effected by a user grabbing the second end 24 of the belt member 20 and pulling orthogonally away from the belt member 20. Such a forcing along an orthogonal direction relative the first and second magnets 32, 42 effects separation without each of said first and second magnets 32, 42 sliding along a shear angle relative each other. Thus separation is effected with relative ease and the second end 24 is deployable as a leash for tethering the animal to the hand of a user expediently when desired. In the embodiment illustrated in FIGS. 1 through 7, the fastener member 26 is configured as a ring member and the belt member 20 is able to slip through the fastener member 26 when deployed in the leash configuration, whereby control of the animal tethered to the user is better effected and pulling by the animal against the leash and the user is thereby preventable due to the collar tightening around the animal's neck.

In an example embodiment shown, the quick release shear resistant magnetic collar and combination leash apparatus 10 includes a handle portion 28 whereby deployment of the leash portion 50 of the belt member 20 as a leash is effected by pulling the handle portion 28 orthogonally from the belt member 20 to best effect separation of the first and second magnets 32, 42, as previously described. The handle portion 28, disposed at the second end 24, may include a visible and/or tactile member to assist in visually locating and effecting manual purchase of the handle portion 28 when desired. The handle portion 28 may also include a loop member for increased tactility in the hand of a user, or to slip the handle portion 28 over the wrist of a user, as desired to more securably wield an animal tethered thereto.

As shown in FIGS. 8 and 9 an embodiment is contemplated whereby the belt member 20 is prevented from slippage through the fastener member 26 when the fastener member 26 is disposed as a ring member. In such embodiments, the belt member 20 does not tighten around the neck of an animal when deployed in the leash configuration but maintains a constant diameter. This embodiment, therefore, includes a fastened point 53, disposed proximal a mid-portion 55 of the belt member 20, whereby the leash portion 50 and the belt member 20 are secured together. In the example illustrated, the fastened point 53 secures the belt member 20 at the mid-portion 55 by action of stitches, however any suitable means of fastening the belt member 20 together with the leash portion 50 at the mid-portion 55 is contemplated.

In this embodiment, the leash portion 50 therefore extends from the fastened point 53 at the mid-portion 55 to the second end 24. Deployment of the leash portion 50 is effected in the same manner as described above, however restoration of the belt member 20 to the encircled configuration is facilitated because each of the first and second magnets 30, 32 line up without a user having to relax or tighten the belt member 20 to realign the first and second magnets 30, 32 together. Because the leash portion 50 is maintained at a constant length in this embodiment, reconnecting the first and second magnets 30, 32 together is facilitated simply by contacting the second end 24 to the belt member 20.

FIG. 10 illustrates an example embodiment wherein a second securement member 54 is used to assist in maintaining connection between the first and second magnets 30, 32. The second securement member 54 is used as an ancillary connector to maintain the second end 24 in contact overlapping the belt member 20, and thus maintain interaction of the first and second magnets 30, 32 along a shear angle. Thus deployment of the leash portion 50 is effected when the second securement member 54 is first disconnected whereby separation of the first and second magnets 30, 32 along the orthogonal direction is facilitated. The second securement member 54 may be an alternate fastener, such as a snap-button for example that readily unseats engagement when force is applied diametrically thereto.

The example embodiment shown in FIG. 11 includes a quick release seat 27 disposed at the first end into which the fastener member 26 releaseably connects. In this embodiment the leash portion 50 is incapable of slippage through the fastener member 26, said fastener member 26 maintained in position at the fold 52 by the fastened point 53. The collar is therefore separable by action of the fastener member 26 depressibly engaging into the quick release seat 27 for fit or removal from an animal, as desired.

Additional embodiments are contemplated within reason of a person having ordinary skill in the art.

What is claimed is:

1. A quick release shear resistant magnetic collar and combination leash apparatus comprising:
a belt member having a first end and a second end;
a fastener member disposed at the first end;
a leash portion disposed at the second end;
a first magnet seat disposed proximal the second end;
a first magnet disposed within the first magnet seat;
a second magnet seat disposed upon the belt member, said second magnet seat spaced apart from the first magnet seat along the length of the belt member; and
a second magnet disposed within the second magnet seat;
wherein the second end is double-backed through the fastener member to position the leash portion encircled overlying the belt member to engage the first and second magnets together and thereby maintain the belt member in an encircled configuration having the second end maintained against the second magnet, whereby manual grasping of the second end enables severing of the first and second magnets to deploy the leash portion into a leash configuration as a short leash.

2. The quick release shear resistant magnetic collar and combination leash apparatus of claim 1 wherein the first and second magnets resist separation along a shear angle effectively to prevent separation unless the handle portion is pulled to separate the first and second magnets by pulling orthogonally relative thereto.

3. The quick release shear resistant magnetic collar and combination leash apparatus of claim 2 wherein the belt member is secured to the leash portion at a fastened point proximate a mid-portion of the belt member whereby slippage of the belt member through the fastener member is prevented and the belt member maintains a constant diameter when worn by an animal.

4. The quick release shear resistant magnetic collar and combination leash apparatus of claim 3 wherein the fastener member includes a quick release seat disposed at the first end, said fastener member releasable from engagement with the quick release seat whereby the fastening member is separable and the belt member openable for fit or removal around the neck of the animal.

5. The quick release shear resistant magnetic collar and combination leash apparatus of claim 2 wherein the leash portion includes a handle portion whereby deployment of the leash portion of the belt member as a short leash is effected by pulling the handle portion orthogonally from the belt member to best effect separation of the first and second magnets versus a sheared separation forced along parallel planes.

6. The quick release shear resistant magnetic collar and combination leash apparatus of claim 5 wherein the second magnet seat is disposed more proximal the first end.

7. The quick release shear resistant magnetic collar and combination leash apparatus of claim 5 wherein the first and second magnets are super neodymium magnets.

8. The quick release shear resistant magnetic collar and combination leash apparatus of claim 6 wherein the first and second magnets are super neodymium magnets.

9. The quick release shear resistant magnetic collar and combination leash apparatus of claim 5 wherein the leash portion of the belt member includes a plurality of magnets disposed within the first magnet seat whereby the diameter of the encircled configuration is variable between each of the plurality of magnets in the first seat engaging with the second magnet in the second magnet seat.

10. The quick release shear resistant magnetic collar and combination leash apparatus of claim 6 wherein the leash portion of the belt member includes a plurality of magnets disposed within the first magnet seat whereby the diameter of the encircled configuration is variable between each of the plurality of magnets in the first seat engaging with the second magnet in the second magnet seat.

11. The quick release shear resistant magnetic collar and combination leash apparatus of claim 7 wherein the leash portion of the belt member includes a plurality of magnets disposed within the first magnet seat whereby the diameter of the encircled configuration is variable between each of the plurality of magnets in the first seat engaging with the second magnet in the second magnet seat.

12. The quick release shear resistant magnetic collar and combination leash apparatus of claim 8 wherein the leash portion of the belt member includes a plurality of magnets disposed within the first magnet seat whereby the diameter of the encircled configuration is variable between each of the plurality of magnets in the first seat engaging with the second magnet in the second magnet seat.

13. The quick release shear resistant magnetic collar and combination leash apparatus of claim 5 wherein the leash portion further includes a second securement member disposed proximal the second end, said second securement member devised to maintain position of the leash portion in overlapped contact with the belt member whereby each of the first and second magnets are separable along an orthogonal direction only after the second securement member has been disengaged.

14. The quick release shear resistant magnetic collar and combination leash apparatus of claim 7 wherein the leash portion further includes a second securement member disposed proximal the second end, said second securement member devised to maintain position of the leash portion in overlapped contact with the belt member whereby each of the first and second magnets are separable along an orthogonal direction only after the second securement member has been disengaged.

15. The quick release shear resistant magnetic collar and combination leash apparatus of claim 8 wherein the leash portion further includes a second securement member disposed proximal the second end, said second securement member devised to maintain position of the leash portion in overlapped contact with the belt member whereby each of the first and second magnets are separable along an orthogonal direction only after the second securement member has been disengaged.

16. The quick release shear resistant magnetic collar and combination leash apparatus of claim 13 wherein the second securement member is a snap-button.

17. The quick release shear resistant magnetic collar and combination leash apparatus of claim 14 wherein the second securement member is a snap-button.

18. The quick release shear resistant magnetic collar and combination leash apparatus of claim 15 wherein the second securement member is a snap-button.
